(19) United States
(12) Patent Application Publication
(10) Pub. No.: US 2026/0153396 A1
(43) Pub. Date: Jun. 4, 2026

(54) ELASTOMER OPTIMIZATION METHOD OF SIX-DIMENSIONAL FORCE SENSOR

(71) Applicant: Harbin Institute of Technology, Harbin (CN)

(72) Inventors: Shicai SHI, Harbin (CN); Haibo YU, Harbin (CN); Yuanfei ZHANG, Harbin (CN); Yongjun SUN, Harbin (CN); Guocai YANG, Harbin (CN); Shaowei FAN, Harbin (CN); Le QI, Harbin (CN); Hong LIU, Harbin (CN)

(21) Appl. No.: 19/405,667

(22) Filed: Dec. 2, 2025

(30) Foreign Application Priority Data
Dec. 2, 2024 (CN) 2024117515475

(51) Int. Cl. G01L 5/1627

(52) U.S. Cl. CPC G01L 5/1627

(57) ABSTRACT

There is provided an elastomer optimization method of a six-dimensional force sensor, which belongs to the field of structure optimization. This method solves the problems of low optimization efficiency and ease of occurrence of non-convergence in the existing elastomer structure optimization method of the six-dimensional force sensor. In the method of the present disclosure, the finite element analysis and the mathematical calculation are combined to screen the main structure parameter variables affecting the condition number and obtain the optimal elastomer safety coefficient fitting function, the optimal elastomer mass fitting function and the optimal condition number fitting function. At the same time, with the screened main structure size parameters as independent variables, the optimal elastomer safety coefficient fitting function as constraint condition, and the minimum value of the weighting function of the optimal condition number fitting function and the optimal mass fitting function as optimization target.

### CROSS-REFERENCE TO RELATED APPLICATION

This application claims priority from the Chinese patent application 2024117515475 filed Dec. 2, 2024, the content of which is incorporated herein in the entirety by reference.

### TECHNICAL FIELD

The present disclosure belongs to the field of structure optimization.

### BACKGROUND

Along with rapid development of humanoid robots, the humanoid robots are available in more and more types. As one of core parts of the humanoid robots, the six-dimensional force sensor needs to adapt to the humanoid robots of different types and different sizes, which requires the elastomer structure of the six-dimensional force sensor to be quickly optimized and designed based on requirements.

In the existing elastomer structure optimization method of the six-dimensional force sensor, only finite element analysis software is commonly used to carry out statics simulation on the elastomer structure so that the range of the to-be-optimized target parameters (including but not limited to one or more combinations of strain beam strain of the elastomer, elastomer safety coefficient, and elastomer structure mass) directly obtained by the finite element analysis software is limited or the human-set to-be-optimized target parameter values are used. Without starting from the essence of the sensor elastomer structure optimization, it is impossible to obtain an optimal solution; or, optimization is carried out by single optimization algorithm in combination with the finite element analysis software. This method, although performing optimization by starting from the essence of the sensor elastomer structure optimization, still has the problems of low optimization efficiency and ease of occurrence of non-convergence. It is necessary to find a quick elastomer structure optimization method of a six-dimensional force sensor.

### SUMMARY

The object of the present disclosure is to solve the problems of low optimization efficiency and ease of occurrence of non-convergence in the existing elastomer structure optimization method of the six-dimensional force sensor. The present disclosure provides an elastomer optimization method of a six-dimensional force sensor.

There is provided an elastomer optimization method of a six-dimensional force sensor, which includes the following steps:
at step 1, a three-dimensional model of an elastomer structure of a to-be-optimized six-dimensional force sensor is imported into a finite element analysis software for parameterization, and multiple structural parameter variables affecting a strain of the elastomer structure, a parameter range of each structure parameter variable, and a range of an elastomer safety coefficient are set;
at step 2, one set of structure parameters is obtained by sequentially selecting parameter values from within the parameter range of each structure parameter variable so as to obtain multiple sets of structure parameters, and then weakly-correlated structure parameter variables are culled by the finite element analysis software and response surface methodology;
at step 3, by using Central Composite Design (CCD) or Box-Behnken, elastomer statics simulation is carried out on each set of structure parameters subjected to weakly-correlated parameter culling to obtain corresponding elastomer safety coefficient, elastomer mass and strain beam strain under the corresponding set;
at step 4, by using the strain beam strain under each set, a strain compliance matrix under corresponding set is obtained, and a condition number of the strain compliance matrix is calculated; where a strain beam is a connection beam attached with a strain gauge in the elastomer structure;
at step 5, by using four response surface model functions, fitting is performed respectively between all sets of structure parameters subjected to weakly-correlated parameter culling and the elastomer safety coefficients corresponding to all sets of structure parameters, so as to obtain four elastomer safety coefficient fitting functions;
by using four response surface model functions, fitting is performed respectively between all sets of structure parameters subjected to weakly-correlated parameter culling and the elastomer masses corresponding to all sets of structure parameters, so as to obtain four elastomer mass fitting functions;
by using four response surface model functions, fitting is performed between all sets of structure parameters subjected to weakly-correlated parameter culling and the condition numbers of the strain compliance matrices corresponding to all sets of structure parameters, so as to obtain four condition number fitting functions;
at step 6, the four elastomer safety coefficient fitting functions, four elastomer mass fitting functions and four condition number fitting functions are screened to obtain an optimal elastomer safety coefficient fitting function, an optimal elastomer mass fitting function and an optimal condition number fitting function;
at step 7, with the parameter range of each structure parameter variable remaining after weakly-correlated parameter culling and a set range of the elastomer safety coefficient, the optimal elastomer safety coefficient fitting function is constrained and the constrained optimal elastomer safety coefficient fitting function is used as constraint condition; meanwhile, with a minimum value of a weighting function constructed by the optimal condition number fitting function and the optimal mass fitting function as optimization target, optimization is carried out by an optimization algorithm to obtain an optimal value of each structure parameter variable remaining after weakly-correlated parameter culling, and an optimal value of the elastomer safety coefficient, an optimal value of the strain beam strain, an optimal value of the elastomer mass, and an optimal value of the condition number corresponding to the structure parameter variables remaining after weakly-correlated parameter culling.

Preferably, the implementation of culling the weakly-correlated structure parameter variables by the finite element analysis software and response surface methodology in the step 2 includes:
by the finite element analysis software, performing elastomer statics simulation on each set of selected structure parameters to obtain corresponding elastomer safety coefficient, elastomer mass and strain beam strain under corresponding set;
based on all sets of structure parameters and all elastomer safety coefficients, elastomer masses and strain beam strains, by using response surface methodology, determining a correlation between each structure parameter variable and the strain beam strain, the elastomer mass and elastomer safety coefficient, and removing weakly-correlated structure parameter variables from all sets of structure parameters.

Preferably, when a correlation value between the corresponding structure parameter variable and the strain beam strain, a correlation value between the corresponding structure parameter variable and the elastomer mass and a correlation value between the corresponding structure parameter variable and the elastomer safety coefficient are all less than a preset correlation value, the structure parameter variable is determined as weakly-correlated structure parameter variable.

Preferably, the structure parameter variable is one or more of a diameter of the elastomer body structure, a diameter of a through hole on the elastomer, a length of a connection beam, a width of the connection beam and a thickness of the connection beam.

Preferably, the four response surface model functions are linear, interactive, quadratic and pure quadratic response surface model functions.

Preferably, the implementation of, by using the strain beam strain under each set, obtaining the strain compliance matrix under corresponding set in the step 4 includes the following steps.
at step 41, for the strain beam strains in the same set, after bridging calculation is performed by Wheatstone Bridge, only the part of the strain calculation is retained to obtain a strain beam strain matrix ε;
where ε=[ε₁ ε₂ . . . ε₆];
ε₁ is the strain beam strain under the force Fx, ε₂ is the strain beam strain under the force Fy, ε₃ is the strain beam strain under the force Fz, ε₄ is the strain beam strain under the moment Mx, ε₅ is the strain beam strain under the moment My, and ε₆ is the strain beam strain under the moment Mz;
F=[Fx Fy Fz Mx My Mz] is a force applied to the to-be-optimized six-dimensional force sensor;
Fx, Fy and Fz are component column vectors of the force applied to the to-be-optimized six-dimensional force sensor in the directions of x, y and z axes of a coordinate system where the force is located, and Mx, My and Mz are component column vectors of the force applied to the optimized six-dimensional force sensor in the directions of x, y and z axes within the coordinate system where the force is located;
at step 42, by using the strain beam strain matrix ε, the strain compliance matrix C_{ε} is obtained and ε=C_{ε}F⁻¹.

Preferably, the implementation of calculating the condition number of the strain compliance matrix in the step 4 includes:

$${C}_{0} = ‖ {C}_{ε} ‖ ‖ {C}_{ε}^{- 1} ‖ ;$$

where C_{ε} is the strain compliance matrix, C₀ is the condition number of the strain compliance matrix, and ∥⋅∥ represents solving a norm for the matrix.

Preferably, the implementation of obtaining the optimal elastomer safety coefficient fitting function, the optimal elastomer mass fitting function and the optimal condition number fitting function in the step 6 includes:
calculating adjusted R-squared statistics of the four elastomer safety coefficient fitting functions and using the elastomer safety coefficient fitting function corresponding to the maximum adjusted R-squared statistic as the optimal elastomer safety coefficient fitting function;
calculating adjusted R-squared statistics of the four elastomer mass fitting functions and using the elastomer mass fitting function corresponding to the maximum adjusted R-squared statistic as the optimal elastomer mass fitting function;
calculating adjusted R-squared statistics of the four condition number fitting functions and using the condition number fitting function corresponding to the maximum adjusted R-squared statistic as the optimal condition number fitting function.

Preferably, the implementation of constructing the weighting function with the optimal condition number fitting function and the optimal mass fitting function in the step 7 includes the followings:

firstly, by using the optimal condition number fitting function ƒ₁ and the optimal mass fitting function ƒ₂, the optimal condition number fitting function and the optimal mass fitting function are standardized to obtain a standardized optimal condition number fitting function ƒ₁ₙₒᵣₘ and a standardized optimal mass fitting function ƒ₂ₙₒᵣₘ;

$${f}_{1 norm} = ( {f}_{1} - {f}_{1 mean} ) / {f}_{1 std} ;$$

$${f}_{2 norm} = ( {f}_{2} - {f}_{2 mean} ) / {f}_{2 std} ;$$

where ƒ₁ₘₑₐₙ, ƒ_{1std}, ƒ₂ₘₑₐₙ and ƒ_{2std} respectively are a mean value of the condition numbers of the corresponding strain compliance matrices under all sets of structure parameters, a standard deviation of the condition numbers of the corresponding strain compliance matrices under all sets of structure parameters, a mean value of the corresponding elastomer masses under all sets of structure parameters, and a standard deviation of the corresponding elastomer masses under all sets of structure parameters before optimization is carried out based on optimization algorithm;

Secondly, based on ƒ₁ₙₒᵣₘ and ƒ₂ₙₒᵣₘ, the weighting function ƒ is constructed;

$$f = {ω}_{1} \cdot {f}_{1 norm} + {ω}_{2} \cdot {f}_{2 norm} ;$$

where ω₁ and ω₂ are weight values of ƒ₁ₙₒᵣₘ and ƒ₂ₙₒᵣₘ respectively, and

$${ω}_{1} + {ω}_{2} = 1.$$

Preferably, in the step 2, all structure parameter variables in each set of structure parameters have the same parameter selection step.

The present disclosure has the following advantages:

The method of the present disclosure adopts the combination of finite element analysis and mathematical calculation to screen the main structure parameter variables affecting the condition number and obtain the optimal elastomer safety coefficient fitting function, the optimal elastomer mass fitting function and the optimal condition number fitting function, and at the same time, with the screened main structure size parameters as independent variables, the optimal elastomer safety coefficient fitting function as constraint condition, and the minimum value of the weighting function of the optimal condition number fitting function and the optimal mass fitting function as optimization target, optimization is carried out. The condition number of the elastomer strain compliance matrix and the elastomer mass can be effectively reduced under the precondition of satisfying the safety coefficient requirement, thereby improving the optimization efficiency and the convergence and converging speed of the optimization algorithm.

### BRIEF DESCRIPTIONS OF THE DRAWINGS

FIG. 1 is a flowchart illustrating an elastomer optimization method of a six-dimensional force sensor in the present disclosure.

FIG. 2 is a structural schematic diagram illustrating an elastomer structure obtained by the optimization method of the present disclosure.

FIG. 3 is a population diversity diagram.

Numerals of the drawings are described below: 1. outer ring, 2. outer ring through hole, 3. flexible beam, 4. parallel beam, 5. double-stiffness stiffening beam, 6. inner beam, 7. inner ring, 8. inner ring through hole, 9. pin hole, 10. tensile strain measurement unit, and 11. shear/compressive strain measurement unit.

### DETAILED DESCRIPTIONS OF EMBODIMENTS

The technical solutions of the embodiments of the present disclosure will be fully and clearly described below in combination with drawings in the embodiments of the present disclosure. Apparently, the described embodiments are merely some embodiments of the present disclosure rather than all embodiments. All other embodiments obtained by those skilled in the arts without carrying out creative work shall fall within the scope of protection of the present disclosure.

It should be noted that in a case of no conflicts, the embodiments in the present disclosure or features in the embodiments can be mutually combined.

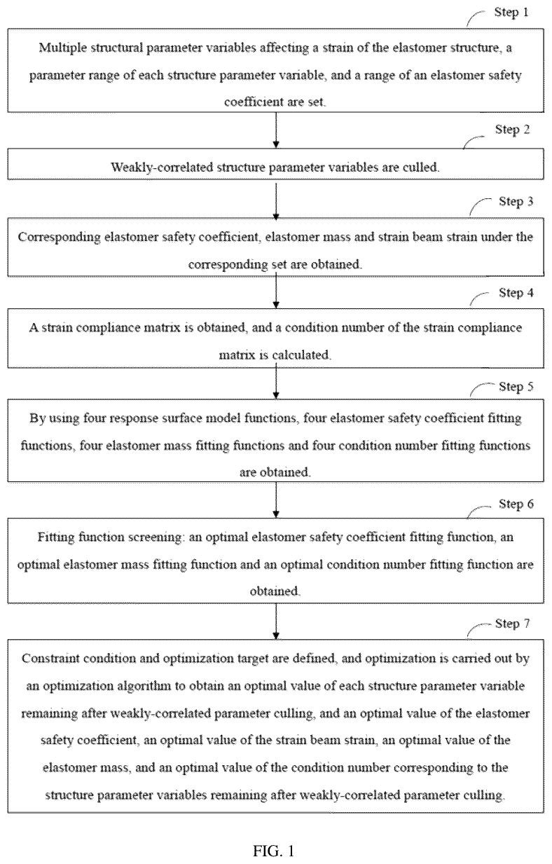

With reference to FIG. 1, it shows an embodiment in which provides an elastomer optimization method of a six-dimensional force sensor, which includes the following steps:
at step 1, a three-dimensional model of an elastomer structure of a to-be-optimized six-dimensional force sensor is imported into a finite element analysis software for parameterization, and multiple structural parameter variables affecting a strain of the elastomer structure, a parameter range of each structure parameter variable, and a range of an elastomer safety coefficient are set;
at step 2, one set of structure parameters is obtained by sequentially selecting parameter values from within the parameter range of each structure parameter variable so as to obtain multiple sets of structure parameters, and then weakly-correlated structure parameter variables are culled by the finite element analysis software and response surface methodology;
at step 3, by using Central Composite Design (CCD) or Box-Behnken, elastomer statics simulation is carried out on each set of structure parameters subjected to weakly-correlated parameter culling to obtain corresponding elastomer safety coefficient, elastomer mass and strain beam strain under the corresponding set;
at step 4, by using the strain beam strain under each set, a strain compliance matrix under corresponding set is obtained, and a condition number of the strain compliance matrix is calculated; where a strain beam is a connection beam attached with a strain gauge in the elastomer structure;
at step 5, by using four response surface model functions, fitting is performed respectively between all sets of structure parameters subjected to weakly-correlated parameter culling and the elastomer safety coefficients corresponding to all sets of structure parameters, so as to obtain four elastomer safety coefficient fitting functions; by using four response surface model functions, fitting is performed respectively between all sets of structure parameters subjected to weakly-correlated parameter culling and the elastomer masses corresponding to all sets of structure parameters, so as to obtain four elastomer mass fitting functions; by using four response surface model functions, fitting is performed between all sets of structure parameters subjected to weakly-correlated parameter culling and the condition numbers of the strain compliance matrices corresponding to all sets of structure parameters, so as to obtain four condition number fitting functions;
at step 6, the four elastomer safety coefficient fitting functions, four elastomer mass fitting functions and four condition number fitting functions are screened to obtain an optimal elastomer safety coefficient fitting function, an optimal elastomer mass fitting function and an optimal condition number fitting function;
at step 7, with the parameter range of each structure parameter variable remaining after weakly-correlated parameter culling and a set range of the elastomer safety coefficient, the optimal elastomer safety coefficient fitting function is constrained and the constrained optimal elastomer safety coefficient fitting function is used as constraint condition; meanwhile, with a minimum value of a weighting function constructed by the optimal condition number fitting function and the optimal mass fitting function as optimization target, optimization is carried out by an optimization algorithm to obtain an optimal value of each structure parameter variable remaining after weakly-correlated parameter culling, and an optimal value of the elastomer safety coefficient, an optimal value of the strain beam strain, an optimal value of the elastomer mass, and an optimal value of the condition number corresponding to the structure parameter variables remaining after weakly-correlated parameter culling.

Specifically, the optimization algorithm includes but not limited to traditional genetic algorithm, and particle population algorithm as well as other traditional optimization algorithms capable of achieving the target optimization and their improved optimization algorithms. The structure parameter variables include the diameter of the elastomer body structure, the diameter of the through hole on the elastomer, the length of the connection beam, the width of the connection beam and the thickness of the connection beam, but are not limited to the above examples.

The traditional optimization method carries out optimization on the sensor by finite element analysis software and can only realize optimization on the limited parameters provided by the finite element analysis software. This method cannot perform matrix calculation and even the calculation of the condition number of the elastomer strain compliance matrix. Therefore, it is impossible to realize joint optimization on the condition number of the elastomer strain compliance matrix and the elastomer mass.

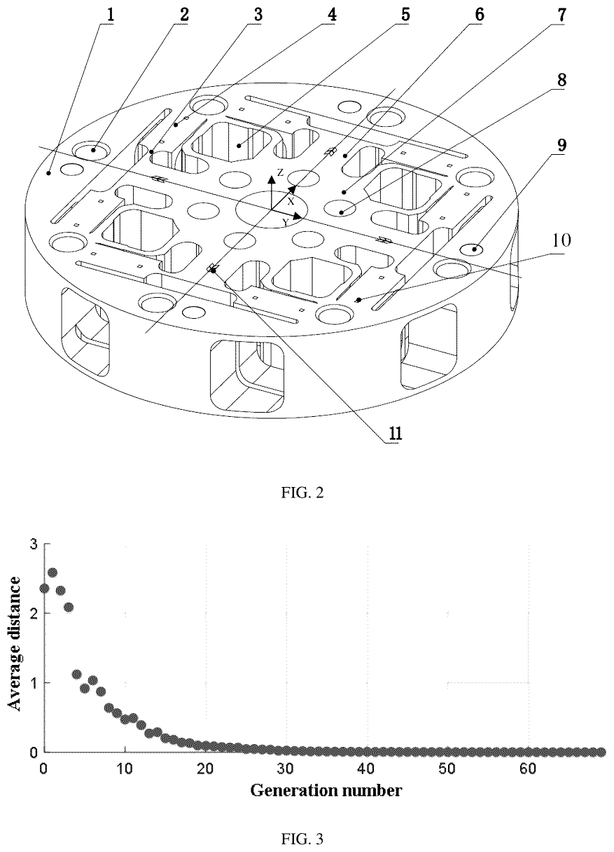

In this implementation, the finite element analysis and the mathematical calculation are combined to screen the main structure parameter variables affecting the condition number and obtain the optimal elastomer safety coefficient fitting function, the optimal elastomer mass fitting function and the optimal condition number fitting function. At the same time, with the screened main structure size parameters as independent variables, the optimal elastomer safety coefficient fitting function as constraint condition, and the minimum value of the weighting function of the optimal condition number fitting function and the optimal mass fitting function as optimization target, optimization is carried out. The condition number of the elastomer strain compliance matrix and the elastomer mass can be effectively reduced under the precondition of satisfying the safety coefficient requirement, thereby improving the optimization efficiency and the convergence and converging speed of the optimization algorithm. Further, the method of present disclosure is applied to design a six-dimensional force sensor, and an exemplary six-dimensional force sensor is presented in FIG. 2 of the present disclosure below. FIG. 2 shows a structural schematic diagram of an optimized elastomer structure by the method of the present disclosure.

According to FIG. 2, the six-dimensional force sensor elastomer designed and obtained by the elastomer optimization method of the present disclosure is described in combination with FIG. 1 below. There is provided a whole-plane six-dimensional force sensor elastomer, which includes an outer ring 1 and an inner ring 7. The outer ring 1 is sleeved on an outer side of the inner ring 7, and four beam assemblies are disposed and connected between the outer ring 1 and the inner ring 7. The four beam assemblies are equidistantly disposed circumferentially between the outer ring 1 and the inner ring 7. An end of each beam assembly is disposed integrally with the outer ring 1 and the other end of each beam assembly is disposed integrally with the inner ring 7. One strain measurement unit assembly is mounted on each beam assembly. In one embodiment, each of the double-stiffness stiffening beams 5 includes four stiffening beam bodies which are sequentially connected head to tail to form a rhombus; two opposite tips of the double-stiffness stiffening beams 5 are connection portions connecting with the outer ring 1 and the inner ring 7 respectively; one tip is disposed integrally with the outer ring 1 and the other tip is disposed integrally with the inner ring 7. each of the beam assemblies includes one inner beam 6 and two parallel beams 4, and one end of the inner beam 6 is disposed integrally with the inner ring 7, and the two parallel beams 4 are disposed oppositely at both sides of the other end of the inner beam 6. One end of each parallel beam 4 is disposed integrally with the inner beam 6 by one flexible beam 3, and the other end of each parallel beam 4 is disposed integrally with the outer ring 1. Each flexible beam 3 and its corresponding parallel beam 4 are located on a same centerline, and each flexible beam 3 is disposed perpendicular to its corresponding inner beam 6. In one embodiment, eight outer ring through holes 2 are circumferentially opened on the top of the outer ring 1, and four of the eight outer ring through holes 2 are respectively disposed corresponding to one double-stiffness stiffening beam 5, and the other four of the eight outer ring through holes 2 are respectively disposed corresponding to one inner beam 6. In one embodiment, each shear/compressive strain measurement unit group includes two shear/compressive strain measurement units 11, and the two shear/compressive strain measurement units 11 are symmetrically mounted on both ends of the top of the parallel beam 4 where the two shear/compressive strain measurement units 11 are located, along a lengthwise centerline of the parallel beam 4. The tensile strain measurement unit 10 on the inner beam 6 and the shear/compressive strain measurement units 11 on the parallel beam 4 are all located within a same plane. In another embodiment, six inner ring through holes 8 are opened equidistantly and circumferentially on the top of the inner ring 7, and two of the six inner ring through holes 8 respectively correspond to two opposite inner beams 6. In another embodiment, four pint holes 9 are also processed on the top of the outer ring 1, and each point hole 9 is located at the other side of the line connecting the central point of the inner ring 7 and the central point of one inner beam 6.

The six-dimensional force sensor elastomer provided by the method of the present disclosure has the following beneficial effects, compared with the prior arts.

1. In the whole-plane six-dimensional force sensor elastomer provided by the method of the present disclosure, the parallel beams are connected to the inner beams by the flexible beams. When a tangential force Fx or Fy acts in a direction perpendicular to a thickness direction of the flexible beams, the stiffness in a length and height direction of the flexible beams is far greater than the stiffness in the thickness direction, leading to smaller coupling effect in My or Mx direction and thus lowering the inter-dimensional coupling. Because the actions of the Mz and Fz are relatively independent, their coupling effect is smaller. The parallel beams are disposed between the flexible beams and the outer ring and the flexible beams are disposed on the centerline of the parallel beams, such that the size of the sensor is less affected by the size of the parallel beams, making the elastomer structure more compact. Furthermore, this arrangement solution also reduces the distance from the flexible beams to the center of the sensor, and hence reduces the torsional deformation of the flexible beams under force, improving the elastomer stiffness and sensitivity.

2. In the whole-plane six-dimensional force sensor elastomer provided by the method of the present disclosure, with the double-stiffness stiffening beams, the axial stiffness can be improved and the elastomer thickness can be reduced, without changing the transverse sensitivity of the elastomer. Furthermore, the problem of excessively increasing the thickness of the parallel beams when increasing the axial stiffness can be avoided and the excessive strain difference of the strain measurement area of the same parallel beam can also be avoided, thereby improving the measurement sensitivity of the elastomer in Fz, Mx and My directions.

3. In the whole-plane six-dimensional force sensor elastomer provided by the method of the present disclosure, the elastomer is designed as whole-plane structure so that the strain measurement units are all located within a same plane of the elastomer and the strain measurement units can be arranged on the elastomer by sputtering process, thereby improving the arrangement accuracy and efficiency of the strain measurement units. Furthermore, the implementation of culling the weakly-correlated structure parameter variables by the finite element analysis software and response surface methodology includes:
by using the finite element analysis software, performing elastomer statics simulation on each set of selected structure parameters to obtain corresponding elastomer safety coefficient, elastomer mass and strain beam strain under the corresponding set;
based on all sets of structure parameters and all elastomer safety coefficients, elastomer masses and strain beam strains, by using response surface methodology, determining a correlation between each structure parameter variable and the strain beam strain, the elastomer mass and elastomer safety coefficient, and removing weakly-correlated structure parameter variables from all sets of structure parameters.

Specifically, when a correlation value between the corresponding structure parameter variable and the strain beam strain, a correlation value between the corresponding structure parameter variable and the elastomer mass and a correlation value between the corresponding structure parameter variable and the elastomer safety coefficient are all less than a preset correlation value, the structure parameter variable is determined as weakly-correlated structure parameter variable.

In this preferred embodiment, it is shown that the method after removing the weakly-correlated structure parameter variables can effectively reduce the selected number of the structure parameters and retain relatively important structure parameters, significantly lowering the total finite element simulation time and improving the optimization efficiency.

Furthermore, the four response surface model functions are linear, interactive, quadratic and pure quadratic response surface model functions.

Furthermore, the implementation of, by using the strain beam strain under each set, obtaining the strain compliance matrix under corresponding set in the step 4 includes the following steps:
at step 41, for the strain beam strains in the same set, after bridging calculation is performed by Wheatstone Bridge, only the part of the strain calculation is retained to obtain the strain beam strain matrix ε;
where ε=[ε₁ ε₂ . . . ε₆];
ε₁ is the strain beam strain under the force Fx, ε₂ is the strain beam strain under the force Fy, ε₃ is the strain beam strain under the force Fz, ε₄ is the strain beam strain under the moment Mx, ε₅ is the strain beam strain under the moment My, and ε₆ is the strain beam strain under the moment Mz;
F=[Fx Fy Fz Mx My Mz] is a force applied to the to-be-optimized six-dimensional force sensor;
Fx, Fy and Fz are component column vectors of the force applied to the to-be-optimized six-dimensional force sensor in the directions of x, y and z axes of a coordinate system where the force is located, and Mx, My and Mz are component column vectors of the force applied to the optimized six-dimensional force sensor in the directions of x, y and z axes within the coordinate system where the force is located;
at step 42, by using the strain beam strain matrix ε, the strain compliance matrix C_{ε} is obtained and ε=C_{ε}F⁻¹.

In this preferred embodiment, the strain beam strain matrix e realizes unified processing on multiple strain beam strains, simplifying calculation flow and promoting extension to high-dimensional problem. The force F is composed of 6 component column vectors on the six-dimensional force sensor so that the force F has an inverse matrix and finally performs matrix calculation with the strain beam strain matrix e to obtain the strain compliance matrix C_{ε}.

Furthermore, the implementation of calculating the condition number of the strain compliance matrix in the step 4 includes:

$${C}_{0} = ‖ {C}_{ε} ‖ ‖ {C}_{ε}^{- 1} ‖ ;$$

where C_{ε} is the strain compliance matrix, C₀ is the condition number of the strain compliance matrix, and ∥⋅∥ represents solving a norm for the matrix.

Furthermore, the implementation of obtaining the optimal elastomer safety coefficient fitting function, the optimal elastomer mass fitting function and the optimal condition number fitting function in the step 6 includes:
calculating adjusted R-squared statistics of the four elastomer safety coefficient fitting functions and using the elastomer safety coefficient fitting function corresponding to the maximum adjusted R-squared statistic as the optimal elastomer safety coefficient fitting function;
calculating adjusted R-squared statistics of the four elastomer mass fitting functions and using the elastomer mass fitting function corresponding to the maximum adjusted R-squared statistic as the optimal elastomer mass fitting function;
calculating adjusted R-squared statistics of the four condition number fitting functions and using the condition number fitting function corresponding to the maximum adjusted R-squared statistic as the optimal condition number fitting function.

In this preferred embodiment, when the optimal elastomer safety coefficient fitting function, the optimal elastomer mass fitting function and the optimal condition number fitting function are selected, four fitting manners are evaluated with the adjusted R-squared statistic as index. This method can effectively evaluate the fitting effect of the evaluation model while avoiding over-fitting problem arising from the evaluation performed based solely on R-squared statistics.

Specifically, the implementation of constructing the weighting function with the optimal condition number fitting function and the optimal mass fitting function in the step 7 includes the followings:
firstly, by using the optimal condition number fitting function ƒ₁ and the optimal mass fitting function ƒ₂, the optimal condition number fitting function and the optimal mass fitting function are standardized to obtain a standardized optimal condition number fitting function ƒ₁ₙₒᵣₘ and a standardized optimal mass fitting function ƒ₂ₙₒᵣₘ;

$${f}_{1 norm} = ( {f}_{1} - {f}_{1 mean} ) / {f}_{1 std} ;$$

$${f}_{2 norm} = ( {f}_{2} - {f}_{2 mean} ) / {f}_{2 std} ;$$

where ƒ₁ₘₑₐₙ, ƒ_{1std}, ƒ₂ₘₑₐₙ and ƒ_{2std} respectively are a mean value of the condition numbers of the corresponding strain compliance matrices under all sets of structure parameters, a standard deviation of the condition numbers of the corresponding strain compliance matrices under all sets of structure parameters, a mean value of the corresponding elastomer masses under all sets of structure parameters, and a standard deviation of the corresponding elastomer masses under all sets of structure parameters before optimization is carried out based on optimization algorithm;

Secondly, based on ƒ₁ₙₒᵣₘ and ƒ₂ₙₒᵣₘ, the weighting function ƒ is constructed;

$$f = {ω}_{1} \cdot {f}_{1 norm} + {ω}_{2} \cdot {f}_{2 norm} ;$$

where ω₁ and ω₂ are weight values of ƒ₁ₙₒᵣₘ and ƒ₂ₙₒᵣₘ respectively, and

$${ω}_{1} + {ω}_{2} = 1$$

In this preferred embodiment, with the minimum value of the weighting function constructed by the optimal condition number fitting function and the optimal mass fitting function as optimization target, optimization is carried out. The condition number of the elastomer strain compliance matrix and the elastomer mass can be effectively reduced under the precondition of satisfying the safety coefficient requirement, thereby improving the optimization efficiency and the convergence and converging speed of the optimization algorithm.

In the specific applications, in the step 2, the selection principle of the parameter values is that: all structure parameter variables in each set of structure parameters have the same parameter selection step.

Embodiment 2: there is provided an elastomer optimization system of a six-dimensional force sensor, which includes a storage device, a processor, and computer programs stored on the storage device and run on the processor. The processor executes the computer programs to perform the elastomer optimization method of the six-dimensional force sensor.

### Verification Experiment

FIG. 3 is a population diversity diagram for reflecting the convergence of the optimization process.

By using the elastomer optimization method of the six-dimensional force sensor in the present disclosure, optimization is performed on the elastomer structure of the to-be-measured six-dimensional force sensor. When the genetic algorithm is used as optimization algorithm, it can be seen from the FIG. 3 showing the population diversity diagram that when the generation number reaches about 30, the average distance tends to be 0, which indicates that the population tends to be centralized, and the target function value has reached the convergence condition. Thus, joint optimization is achieved on the condition number of the elastomer strain compliance matrix and the elastomer mass. In the present disclosure, the method uses the strain beam strain under each set to obtain the strain compliance matrix under corresponding set, and calculate the condition number of the strain compliance matrix; at the same time, joint optimization is performed on the condition number of the elastomer strain compliance matrix and the elastomer mass so that the target function value can converge quickly. FIG. 3 shows the effectiveness of the present disclosure.

### Working Principle:

Taking the measurement of the tangential force Fx as example: the tangential force Fx is applied to the lower end surface of the inner ring 7, and the upper end surface of the outer ring 1 is a fixed surface, and the stiffness of the flexible beams 3 in the length direction (in the X axis direction) is greater than the stiffness in the thickness direction (in the Y axis direction). Therefore, the inner beams 6, the parallel beams 4, the double-stiffness stiffening beams 5 and the flexible beams 3 in parallel to the Fx direction are all regarded as stiff, and the inner beams 6, the parallel beams 4, the double-stiffness stiffening beams 5 and the flexible beams 3 perpendicular to the Fx direction are all regarded as flexible, and the inner beams 6 perpendicular to the Fx direction are regarded as cantilever beams. A strain sensitivity area is formed on the inner beams 6. In this way, a strain bridge is formed to measure Fx. Similarly, the tangential force Fy can be measured.

Taking the measurement of the axial force Fz as example: the axial force Fz is applied to the lower end surface of the inner ring 7, the upper end surface of the outer ring 1 is a fixed surface, and the force is transmitted to the parallel beams 4 by the inner beams 6. The stiffness of the flexible beams 3 and the double-stiffness stiffening beams 5 in the Z axis direction is greater than the stiffness in the X axis and Y axis directions, and the stiffness of the parallel beams 4 in the X axis and Y axis directions is greater than the stiffness in the Z axis direction. Therefore, the inner beams 6, the double-stiffness stiffening beams 5 and the flexible beams 3 are regarded as stiff, and the parallel beams 4 are regarded as flexible. The axial force Fz is transmitted to the parallel beams 4 by the four uniformly-distributed inner beams 6 and the flexible beams 3. A strain sensitivity area is formed on the parallel beams 4 and thus a strain bridge is formed to measure the Fz.

Taking the measurement of the bending moment Mx as example: the bending moment Mx is applied to the lower end surface of the inner ring 7, the upper end surface of the outer ring 1 is a fixed surface, and the bending moment is transmitted to the parallel beams 4 by the inner beams 6. The stiffness of the flexible beams 3 and the double-stiffness stiffening beams 5 in the Z axis direction is greater than the stiffness in the X axis and Y axis directions, and the stiffness of the parallel beams 4 in the X axis and Y axis directions is greater than the stiffness in the Z axis direction. Therefore, the inner beams 6, the double-stiffness stiffening beams 5 and the flexible beams 3 are regarded as stiff, and the parallel beams 4 are regarded as flexible. The bending moment Mx is transmitted to the parallel beams 4 by the four uniformly-distributed inner beams 6 and the flexible beams 3. A strain sensitivity area is formed on the parallel beams 4 and thus a strain bridge is formed to measure the Mx. Similarly, the tangential force My can be measured.

Taking the measurement of the torque Mz as example: the torque Mz is applied to the lower end surface of the inner ring 7, the upper end surface of the outer ring 1 is a fixed surface, and the stiffness of the flexible beams 3 in the length and Z axis directions is greater than the stiffness in the thickness direction. The actual action of the torque Mz is equivalent to a pile of couples of same size. Assuming the directions of the two acting forces of the couples are parallel to the X axis, the inner beams 6, the parallel beams 4 and the flexible beams 3 with the length direction parallel to the X axis direction are all regarded as stiff, and the flexible beams 3 with the length direction parallel to the Y axis direction are regarded as flexible. At this point, the inner beams 6 in parallel to the Y axis direction are regarded as cantilever beams. A strain sensitivity area is formed on the inner beams 6 and thus a strain bridge is formed to measure the Mz.

Although the present disclosure is described by referring to the specific embodiments in the present disclosure, it should be understood that these embodiments are merely examples of the principle and applications of the present disclosure. Therefore, it should be understood that the exemplary embodiments can be modified to design other arrangements without departing from the spirit and scope of the claims appended to the present disclosure. It should be understood that different dependent claims and features herein can be combined in a way different from those in the original claims. It can be further understood that the features described in combination with individual embodiment can be applied to other embodiments.
finite element analysis and the mathematical calculation are combined to screen the main structure parameter variables affecting the condition number and obtain the optimal elastomer safety coefficient fitting function, the optimal elastomer mass fitting function and the optimal condition number fitting function. At the same time, with the screened main structure size parameters as independent variables, the optimal elastomer safety coefficient fitting function as constraint condition, and the minimum value of the weighting function of the optimal condition number fitting function and the optimal mass fitting function as optimization target, optimization is carried out, improving the optimization efficiency and bringing ease of convergence of the optimization process. The present disclosure is mainly applied to the field of the elastomer structure optimization of the force sensor.

1. An elastomer optimization method of a six-dimensional force sensor, comprising the following steps:
at step 1, a three-dimensional model of an elastomer structure of a to-be-optimized six-dimensional force sensor is imported into a finite element analysis software for parameterization, and multiple structural parameter variables affecting a strain of the elastomer structure, a parameter range of each structure parameter variable, and a range of an elastomer safety coefficient are set;
at step 2, one set of structure parameters is obtained by sequentially selecting parameter values from within the parameter range of each structure parameter variable so as to obtain multiple sets of structure parameters, and then weakly-correlated structure parameter variables are culled by the finite element analysis software and response surface methodology;
at step 3, by using Central Composite Design (CCD) or Box-Behnken, elastomer statics simulation is carried out on each set of structure parameters subjected to weakly-correlated parameter culling to obtain corresponding elastomer safety coefficient, elastomer mass and strain beam strain under the corresponding set;
at step 4, by using the strain beam strain under each set, a strain compliance matrix under corresponding set is obtained, and a condition number of the strain compliance matrix is calculated; wherein a strain beam is a connection beam attached with a strain gauge in the elastomer structure;
at step 5, by using four response surface model functions, fitting is performed respectively between all sets of structure parameters subjected to weakly-correlated parameter culling and the elastomer safety coefficients corresponding to all sets of structure parameters, so as to obtain four elastomer safety coefficient fitting functions;
by using four response surface model functions, fitting is performed respectively between all sets of structure parameters subjected to weakly-correlated parameter culling and the elastomer masses corresponding to all sets of structure parameters, so as to obtain four elastomer mass fitting functions;
by using four response surface model functions, fitting is performed between all sets of structure parameters subjected to weakly-correlated parameter culling and the condition numbers of the strain compliance matrices corresponding to all sets of structure parameters, so as to obtain four condition number fitting functions;
at step 6, the four elastomer safety coefficient fitting functions, four elastomer mass fitting functions and four condition number fitting functions are screened to obtain an optimal elastomer safety coefficient fitting function, an optimal elastomer mass fitting function and an optimal condition number fitting function;
at step 7, with the parameter range of each structure parameter variable remaining after weakly-correlated parameter culling and a set range of the elastomer safety coefficient, the optimal elastomer safety coefficient fitting function is constrained and the constrained optimal elastomer safety coefficient fitting function is used as constraint condition; meanwhile, with a minimum value of a weighting function constructed by the optimal condition number fitting function and the optimal mass fitting function as optimization target, optimization is carried out by an optimization algorithm to obtain an optimal value of each structure parameter variable remaining after weakly-correlated parameter culling, and an optimal value of the elastomer safety coefficient, an optimal value of the strain beam strain, an optimal value of the elastomer mass, and an optimal value of the condition number corresponding to the structure parameter variables remaining after weakly-correlated parameter culling.

2. The elastomer optimization method of the six-dimensional force sensor according to claim 1, wherein the implementation of culling the weakly-correlated structure parameter variables by the finite element analysis software and response surface methodology in the step 2 comprises:
by the finite element analysis software, performing elastomer statics simulation on each set of selected structure parameters to obtain corresponding elastomer safety coefficient, elastomer mass and strain beam strain under corresponding set;
based on all sets of structure parameters and all elastomer safety coefficients, elastomer masses and strain beam strains, by using response surface methodology, determining a correlation between each structure parameter variable and the strain beam strain, the elastomer mass and elastomer safety coefficient, and removing weakly-correlated structure parameter variables from all sets of structure parameters.

3. The elastomer optimization method of the six-dimensional force sensor according to claim 2, wherein when a correlation value between the corresponding structure parameter variable and the strain beam strain, a correlation value between the corresponding structure parameter variable and the elastomer mass and a correlation value between the corresponding structure parameter variable and the elastomer safety coefficient are all less than a preset correlation value, the structure parameter variable is determined as weakly-correlated structure parameter variable.

4. The elastomer optimization method of the six-dimensional force sensor according to claim 1, wherein the structure parameter variable is one or more of a diameter of the elastomer body structure, a diameter of a through hole on the elastomer, a length of a connection beam, a width of the connection beam and a thickness of the connection beam.

5. The elastomer optimization method of the six-dimensional force sensor according to claim 1, wherein the four response surface model functions are linear, interactive, quadratic and pure quadratic response surface model functions.

6. The elastomer optimization method of the six-dimensional force sensor according to claim 1, wherein the implementation of, by using the strain beam strain under each set, obtaining the strain compliance matrix under corresponding set in the step 4 comprises the following steps:
at step 41, for the strain beam strains in the same set, after bridging calculation is performed by Wheatstone Bridge, only the part of the strain calculation is retained to obtain a strain beam strain matrix ε;
wherein ε=[ε₁ ε₂ . . . ε₆];
ε₁ is the strain beam strain under the force Fx, ε₂ is the strain beam strain under the force Fy, ε₃ is the strain beam strain under the force Fz, ε₄ is the strain beam strain under the moment Mx, ε₅ is the strain beam strain under the moment My, and ε₆ is the strain beam strain under the moment Mz;
F=[Fx Fy Fz Mx My Mz] is a force applied to the to-be-optimized six-dimensional force sensor;
Fx, Fy and Fz are component column vectors of the force applied to the to-be-optimized six-dimensional force sensor in the directions of x, y and z axes of a coordinate system where the force is located, and Mx, My and Mz are component column vectors of the force applied to the optimized six-dimensional force sensor in the directions of x, y and z axes within the coordinate system where the force is located;
at step 42, by using the strain beam strain matrix ε, the strain compliance matrix C_{ε} is obtained and ε=C_{ε}F⁻¹.

7. The elastomer optimization method of the six-dimensional force sensor according to claim 1, wherein the implementation of calculating the condition number of the strain compliance matrix in the step 4 comprises:
$${C}_{0} = ‖ {C}_{ε} ‖ ‖ {C}_{ε}^{- 1} ‖ ;$$
wherein C_{ε} is the strain compliance matrix, C₀ is the condition number of the strain compliance matrix, and ∥⋅∥ represents solving a norm for the matrix.

8. The elastomer optimization method of the six-dimensional force sensor according to claim 1, wherein the implementation of obtaining the optimal elastomer safety coefficient fitting function, the optimal elastomer mass fitting function and the optimal condition number fitting function in the step 6 comprises:
calculating adjusted R-squared statistics of the four elastomer safety coefficient fitting functions and using the elastomer safety coefficient fitting function corresponding to the maximum adjusted R-squared statistic as the optimal elastomer safety coefficient fitting function;
calculating adjusted R-squared statistics of the four elastomer mass fitting functions and using the elastomer mass fitting function corresponding to the maximum adjusted R-squared statistic as the optimal elastomer mass fitting function;
calculating adjusted R-squared statistics of the four condition number fitting functions and using the condition number fitting function corresponding to the maximum adjusted R-squared statistic as the optimal condition number fitting function.

9. The elastomer optimization method of the six-dimensional force sensor according to claim 1, wherein the implementation of constructing the weighting function with the optimal condition number fitting function and the optimal mass fitting function in the step 7 comprises the followings:
firstly, by using the optimal condition number fitting function ƒ₁ and the optimal mass fitting function ƒ₂, the optimal condition number fitting function and the optimal mass fitting function are standardized to obtain a standardized optimal condition number fitting function ƒ₁ₙₒᵣₘ and a standardized optimal mass fitting function ƒ₂ₙₒᵣₘ,
$${f}_{1 norm} = ( {f}_{1} - {f}_{1 mean} ) / {f}_{1 std} ;$$
$${f}_{2 norm} = ( {f}_{2} - {f}_{2 mean} ) / {f}_{2 std} ;$$
wherein ƒ₁ₘₑₐₙ, ƒ_{1std}, ƒ₂ₘₑₐₙ and ƒ_{2std} respectively are a mean value of the condition numbers of the corresponding strain compliance matrices under all sets of structure parameters, a standard deviation of the condition numbers of the corresponding strain compliance matrices under all sets of structure parameters, a mean value of the corresponding elastomer masses under all sets of structure parameters, and a standard deviation of the corresponding elastomer masses under all sets of structure parameters before optimization is carried out based on optimization algorithm;
Secondly, based on ƒ₁ₙₒᵣₘ and ƒ₂ₙₒᵣₘ, the weighting function ƒ is constructed;
$$f = {ω}_{1} \cdot {f}_{1 norm} + {ω}_{2} \cdot {f}_{2 norm} ;$$
wherein ω₁ and ω₂ are weight values of ƒ₁ₙₒᵣₘ and ƒ₂ₙₒᵣₘ respectively, and ω₁+ω₂=1.

10. The elastomer optimization method of the six-dimensional force sensor according to claim 1, wherein in the step 2, all structure parameter variables in each set of structure parameters have the same parameter selection step.
